(19) United States
(12) Patent Application Publication
(10) Pub. No.: US 2022/0108682 A1
(43) Pub. Date: Apr. 7, 2022

(54) GENERATION CONTROL DEVICE FOR VOICE MESSAGE-CONTAINING IMAGE AND METHOD FOR GENERATING SAME

(71) Applicant: SHARP KABUSHIKI KAISHA, Sakai City (JP)

(72) Inventors: YASUHIRO NAKAI, Sakai City (JP); KOHICHI MURAKAMI, Sakai City (JP); YOSHIAKI TANAKA, Sakai City (JP); TAKAYA NAKATANI, Sakai City (JP); TAKAYUKI KANOH, Sakai City (JP)

(21) Appl. No.: 17/486,617

(22) Filed: Sep. 27, 2021

(30) Foreign Application Priority Data
Oct. 6, 2020 (JP) 2020-169326

(51) Int. Cl. G10L 13/08; G10L 13/027; G10L 13/047

(52) U.S. Cl. CPC G10L 13/08; G10L 13/047; G10L 13/027

(57) ABSTRACT

A generation control device for a voice message-containing image includes: a selection receiver that receives the selection of any one of images that can be provided and the selection or input of spoken content to be associated with the selected image; a voice data generation processing processor that generates voice data of the spoken content which is selected or input; a voice data storage processing processor that stores the generated voice data to be accessible; an access information superimposer that superimposes access information to the stored voice data on the selected image; and an image storage processing processor that stores a voice message-containing image on which the access information is superimposed such that the voice message-containing image can be output.

### BACKGROUND OF THE INVENTION

### Field of the Invention

This invention relates to a generation control device for generation processing of a voice message-containing image using a voice synthesis technique and a method for generating the voice message-containing image.

### Description of the Background Art

Voice synthesis is used, for example, in a field where a given voice message is reproduced in an answering machine function and in a field of the function of reading text information. In recent years, as voice synthesis techniques have further developed, more advanced voice synthesis functions and applications have been provided as voice synthesis services. In an example of the services, when a certain user selects a speaker and inputs text which it is desired to cause the speaker to speak, even if voice data which is recorded according to the text is not present, a natural synthetic voice of the speaker is generated and provided (see, for example, “New culture is generated from voice synthesis?”, [online], Sep. 14, 2017, AV Watch, [searched on Sep. 14, 2020], the Internet <URL:https://av.watch.impress.co.jp/docs/topic/1077565.html>). This service utilizes the capability of accurately and easily synthesizing a synthetic voice similar to a specific speaker.

As a technique which supports the service, for example, a dictionary distribution system is proposed that distributes a dictionary which makes it possible to synthesize voices of many speakers even in a terminal where the specifications of hardware is limited and which is optimally configured (see, for example, Japanese Unexamined Patent Application Publication No. 2019-040166).

Conventionally, celebrities called talents and artists have provided portrait photographs called so-called bromides to supporters. Images such as a portrait photograph show well the characteristics of a person who is shot and are said to be representative examples of a medium which causes others to recall the presence of the person.

If it is possible to associate a voice of the person with the portrait photograph and also to personalize the content of the voice, the value of the portrait photograph for supporters can be more enhanced.

In order to make it possible to flexibly personalize a voice message, it is preferable to store the data (voice data) of the generated voice message in a predetermined place and to collectively manage it.

This invention is made in view of the circumstances described above, and provides a method for generating a voice message-containing image in which access information to the voice data of spoken content selected or input by a user is superimposed on an image selected by the user.

### SUMMARY OF THE INVENTION

This invention provides a generation control device for a voice message-containing image, and the generation control device includes: a selection receiver that receives the selection of any one of images that can be provided and the selection or input of spoken content to be associated with the selected image; a voice data generation processing processor that generates voice data of the spoken content which is selected or input; a voice data storage processing processor that stores the generated voice data to be accessible; an access information superimposer that superimposes access information to the stored voice data on the selected image; and an image storage processing processor that stores a voice message-containing image on which the access information is superimposed such that the voice message-containing image can be output.

From a different point of view, this invention provides a method for generating a voice message-containing image, and the method includes: receiving, by a processor, the selection of any one of images that can be provided and the selection or input of spoken content to be associated with the selected image; generating, by the processor, voice data of the spoken content which is selected or input; storing, by the processor, the generated voice data to be accessible; superimposing, by the processor, access information to the stored voice data on the selected image; and storing, by the processor, a voice message-containing image on which the access information is superimposed such that the voice message-containing image can be output.

A generation control device for a voice message-containing image according to this invention includes a voice data generation processing processor that generates voice data of spoken content selected or input by a user; and an access information superimposer that superimposes access information to the voice data on an image selected by the user, and thus it is possible to generate a voice message-containing image in which the access information to the voice data of the spoken content selected or input by the user is superimposed on the image selected by the user.

### BRIEF DESCRIPTION OF THE DRAWINGS

FIG. 1 is a block diagram showing an example of a configuration of a generation control device for the generation of a voice message-containing image in this embodiment. (embodiment 1)

FIG. 2 is a block diagram showing an example of a different configuration of the generation control device for the generation of the voice message-containing image in this embodiment. (embodiment 2)

FIG. 3A is a first flowchart showing the flow of processing for the generation of the voice message-containing image in this embodiment. (embodiment 2)

FIG. 3B is a second flowchart showing the flow of the processing for the generation of the voice message-containing image in this embodiment. (embodiment 2)

FIG. 3C is a third flowchart showing the flow of the processing for the generation of the voice message-containing image in this embodiment. (embodiment 2)

FIG. 4A is an illustrative view showing a first operation for the generation of the voice message-containing image in this embodiment. (embodiment 2)

FIG. 4B is an illustrative view showing a second operation for the generation of the voice message-containing image in this embodiment. (embodiment 2)

FIG. 4C is an illustrative view showing a third operation for the generation of the voice message-containing image in this embodiment. (embodiment 2)

FIG. 4D is an illustrative view showing a fourth operation for the generation of the voice message-containing image in this embodiment. (embodiment 2)

FIG. 5 is an illustrative view showing an example of the voice message-containing image and an example of an operation of reproducing a voice message in this embodiment. (embodiment 2)

FIG. 6 is an illustrative view showing an example of the presentation of identification information for the voice message-containing image to a user in this embodiment. (embodiment 2)

FIG. 7 is a flowchart showing the flow of processing for the output of the voice message-containing image in this embodiment.

FIG. 8 is a flowchart showing the flow of processing for the reproduction of the voice message-containing image in this embodiment.

### DESCRIPTION OF THE PREFERRED EMBODIMENTS

This invention will be described in more detail below with reference to drawings. The following description is illustrative in all respects and should not be considered to limit this invention.

### Embodiment 1

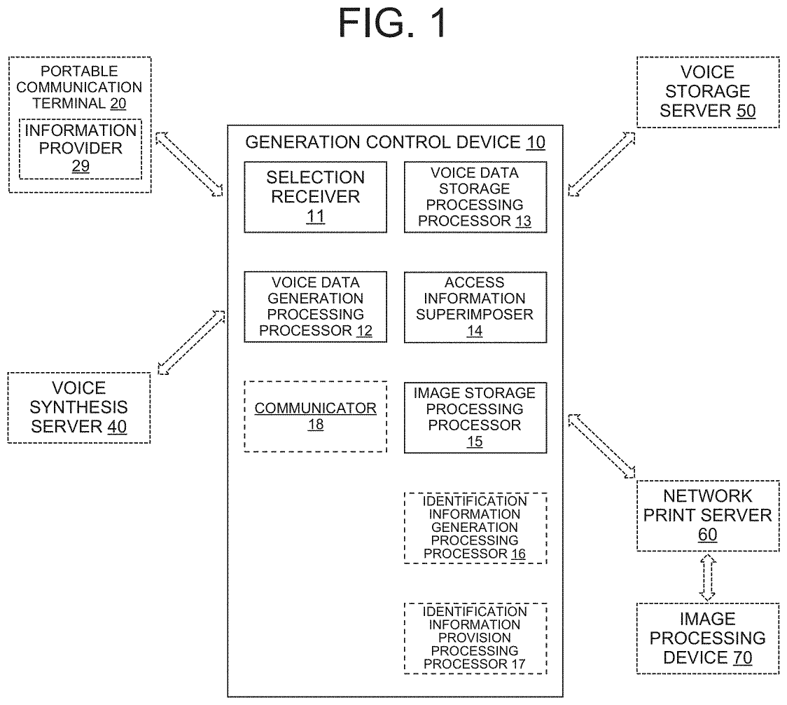

FIG. 1 is a block diagram showing an example of a configuration of a generation control device for the generation of a voice message-containing image in this embodiment.

As shown in FIG. 1, the generation control device 10 for the voice message-containing image includes a selection receiver 11, a voice data generation processing processor 12, a voice data storage processing processor 13, an access information superimposer 14 and an image storage processing processor 15. The generation control device 10 may further include an identification information generation processing processor 16, an identification information provision processing processor 17 and a communicator 18.

Examples of the specific form of the generation control device 10 include a personal computer including a processor, a tablet terminal, a smart phone and the like. The functions of the selection receiver 11, the voice data generation processing processor 12, the voice data storage processing processor 13, the access information superimposer 14 and the image storage processing processor 15 are realized as a result of the execution of predetermined processing programs by the processor of the generation control device 10. The same is true for the identification information generation processing processor 16 and the identification information provision processing processor 17.

The selection receiver 11 receives the selection of an image used for the voice message-containing image by a user. Furthermore, the selection receiver 11 performs processing for receiving the selection or input of the content (spoken content) of a voice message by the user. The selection receiver 11 may include an operation input device for receiving the input of an operation by the user so as to receive operations of the user for the selection of the image and the selection or input of the content of the voice message. As indicated by dashed lines in FIG. 1, the generation control device 10 may also include the communicator 18 which communicates with an external device (portable communication terminal 20 in the example of FIG. 1) such that the selection receiver 11 receives operations for the selection of the image and the selection or input of the content of the voice message performed by the user on the portable communication terminal 20. The portable communication terminal 20 may include an information provider 29 which provides at least any one of position information, period information related to a date and the like and time information in hours, minutes and seconds.

The voice data generation processing processor 12 performs processing for generating voice data based on the content of the voice message selected or input by the user. The voice data generation processing processor 12 may have the function of performing voice synthesis to generate the voice data based on the content of the voice message selected or input by the user. As indicated by dashed lines in FIG. 1, the generation control device 10 may also include the communicator 18 which communicates with an external device (voice synthesis server 40 in the example of FIG. 1) such that the voice data generation processing processor 12 causes the voice synthesis server 40 for performing the voice synthesis to generate the voice data and thereby acquires the generated voice data.

The voice data storage processing processor 13 performs processing for storing the generated voice data to be accessible based on the access information. The voice data storage processing processor 13 may include a storage device for storing the voice data so as to store the generated voice data in the storage device within the generation control device 10. The access information is information for identifying a place within the storage device where the voice data is stored. As indicated by dashed lines in FIG. 1, the voice data storage processing processor 13 may also include the communicator 18 which communicates with an external device (voice storage server 50 in the example of FIG. 1) such that the voice data storage processing processor 13 performs control to store the voice data in the voice storage server 50. The access information is information for identifying a place in the voice storage server 50 where the voice data is stored.

Furthermore, although when the voice data is generated with the voice synthesis server 40, the generated voice data may be temporarily acquired and stored in the voice storage server 50, an instruction to transmit the generated voice data to the voice storage server 50 and store it therein may be provided to the voice synthesis server 40. In such a case, an instruction is provided to transmit the access information from the voice storage server 50 to the voice data storage processing processor.

The access information superimposer 14 performs processing for acquiring the access information used for access to the voice data, converting the information into the form of an image and superimposing such an image on the image selected by the user to generate the voice message-containing image.

The image storage processing processor 15 performs processing for storing the generated voice message-containing image such that the generated voice message-containing image can be output. The image storage processing processor 15 may include a storage device for storing the voice message-containing image so as to store the generated voice message-containing image in the storage device within the generation control device 10. As indicated by dashed lines in FIG. 1, the generation control device 10 may also include the communicator 18 which communicates with an external device (network print server 60 in the example of FIG. 1) such that the image storage processing processor 15 performs control to store the voice message-containing image in the network print server 60.

Although the voice message-containing image may be output to, for example, a display (not shown) included in the generation control device 10, the voice message-containing image may be output to an external device (image processing device 70 in the example of FIG. 1). When the voice message-containing image is stored in the network print server 60, the output of the stored voice message-containing image may be performed between the image processing device 70 and the network print server 60 without the intervention of the generation control device 10.

### Embodiment 2

In the description of embodiment 1, at least any one of the selection receiver 11, the voice data generation processing processor 12, the voice data storage processing processor 13, the access information superimposer 14 and the image storage processing processor 15 in the generation control device 10 may cause the eternal device to perform the processing. In this embodiment, the generation control device 10 controls a procedure for the generation of the voice message-containing image to cause the external devices to perform the processing of the procedure.

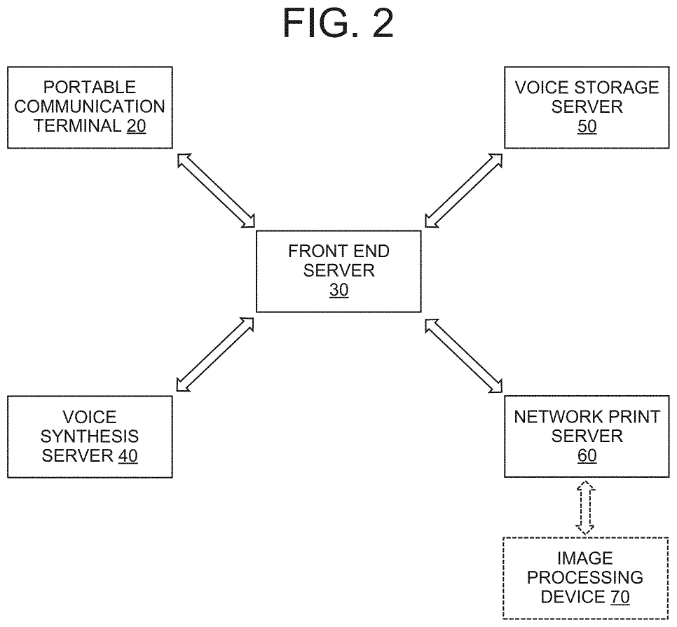

FIG. 2 is a block diagram showing an example of a configuration of the generation control device for the generation of the voice message-containing image in this embodiment. When the block diagram shown in FIG. 2 is made to correspond to the block diagram of FIG. 1, it is understood that a front end server 30 corresponds to the generation control device 10 of FIG. 1. Since this embodiment has a configuration with the assumption that the portable communication terminal 20, the voice synthesis server 40, the voice storage server 50 and the network print server 60 are provided, they are indicated by solid lines.

The front end server 30 may be formed as a so-called cloud server with a plurality of devices without being physically formed with one server. As a variation of the example shown in FIG. 2, the cloud server described above may include the function of at least part of any one of the voice synthesis server 40, the voice storage server 50 and the network print server 60.

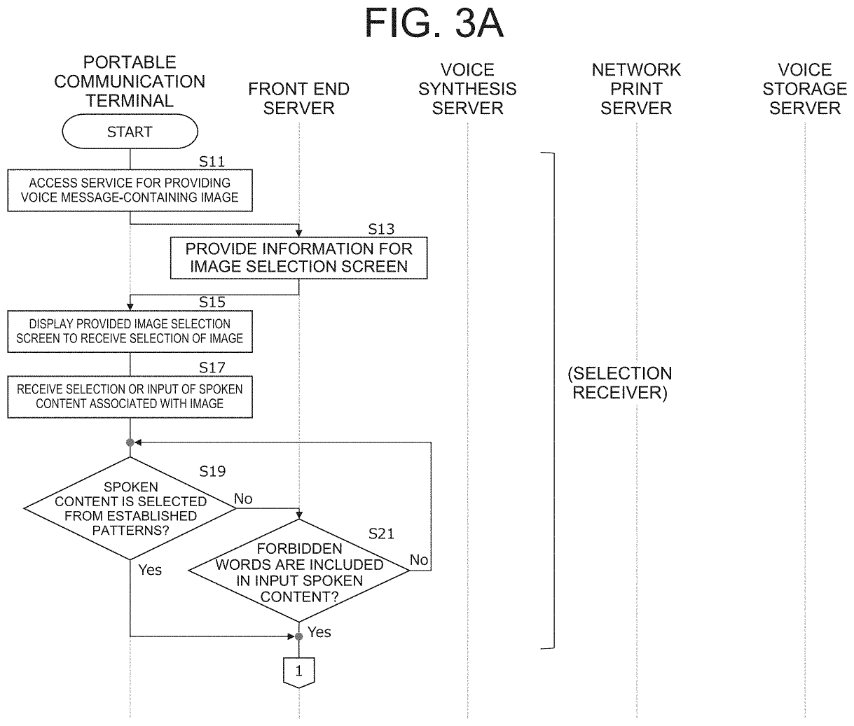

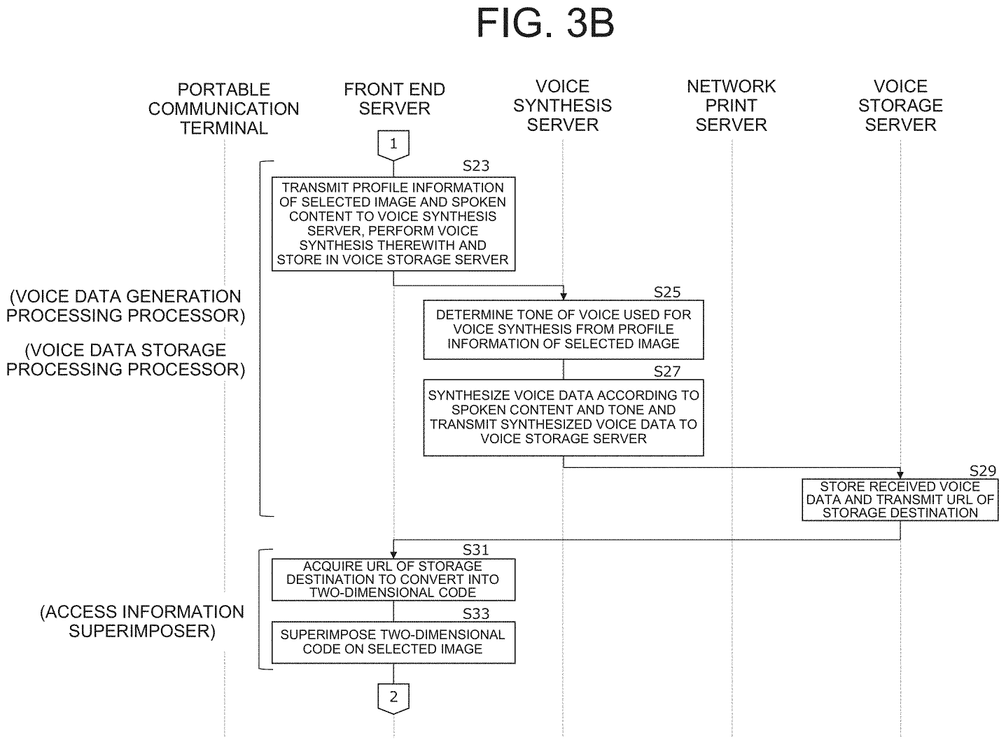

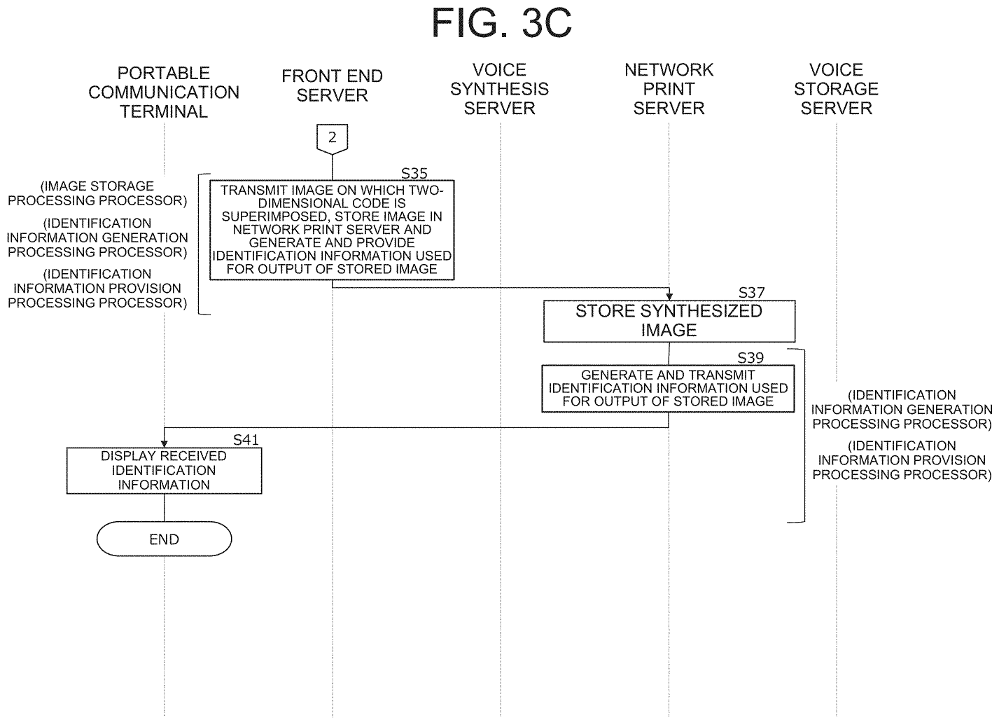

FIGS. 3A to 3C are a first flowchart showing the flow of processing for the generation of the voice message-containing image in this embodiment. Processing in the configuration of embodiment 1 shown in FIG. 1 can easily be understood by a person skilled in the art from the processing of embodiment 2 in FIGS. 3A to 3C.

As shown in FIG. 3A, the user uses the portable communication terminal 20 to access a service for the voice message-containing image (step S11).

The access to the service may be performed by browsing a predetermined web page determined by the provider of the service or may be performed with an SNS (Social Network Service). A request for the service accessed from the portable communication terminal 20 is processed by the front end server 30.

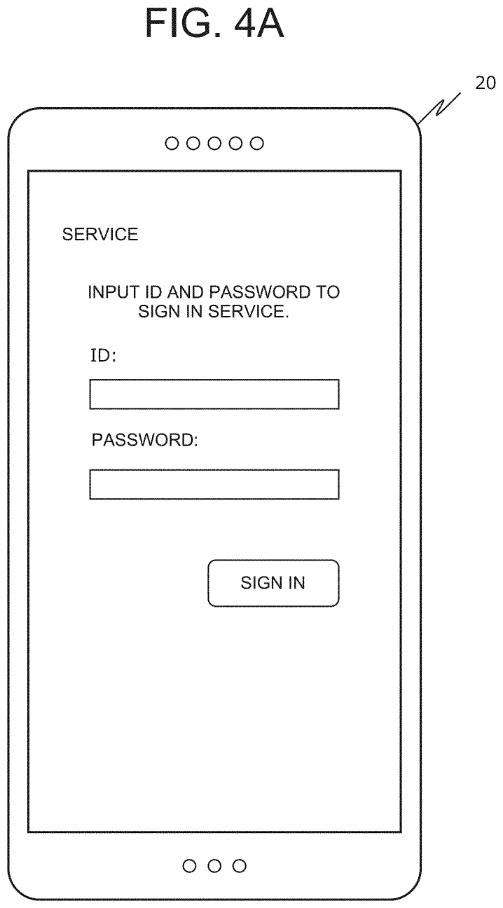

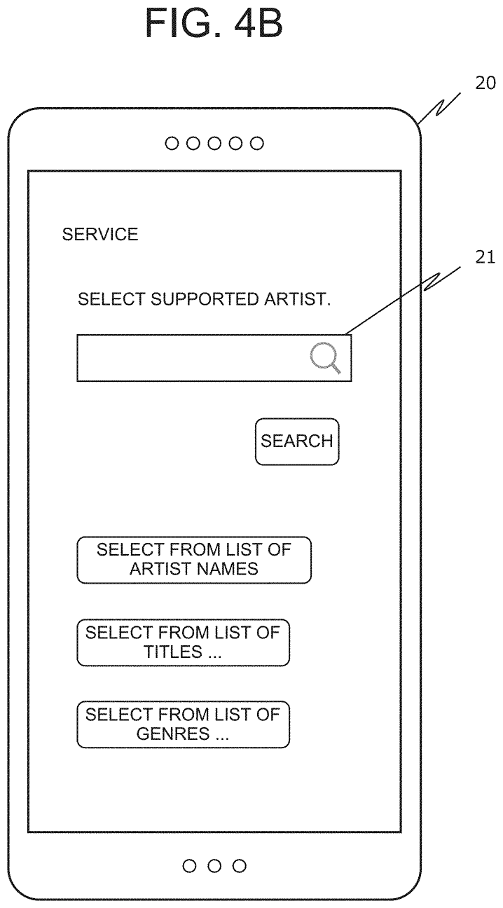

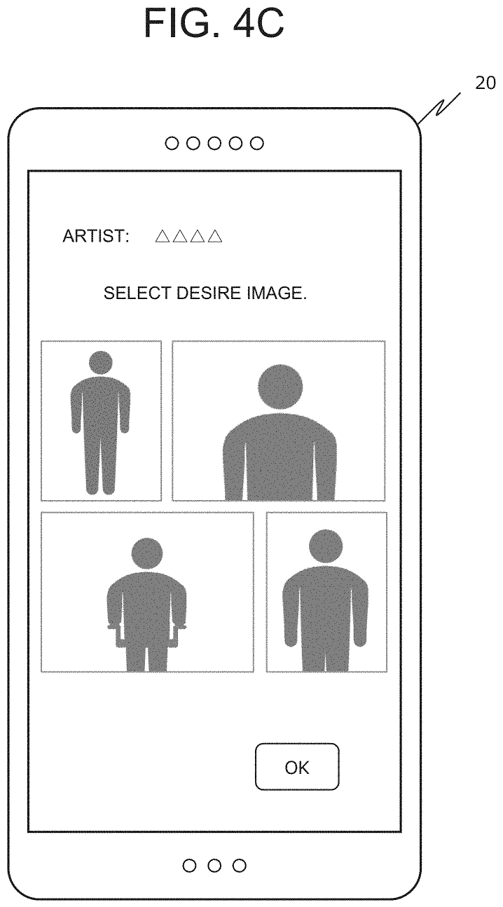

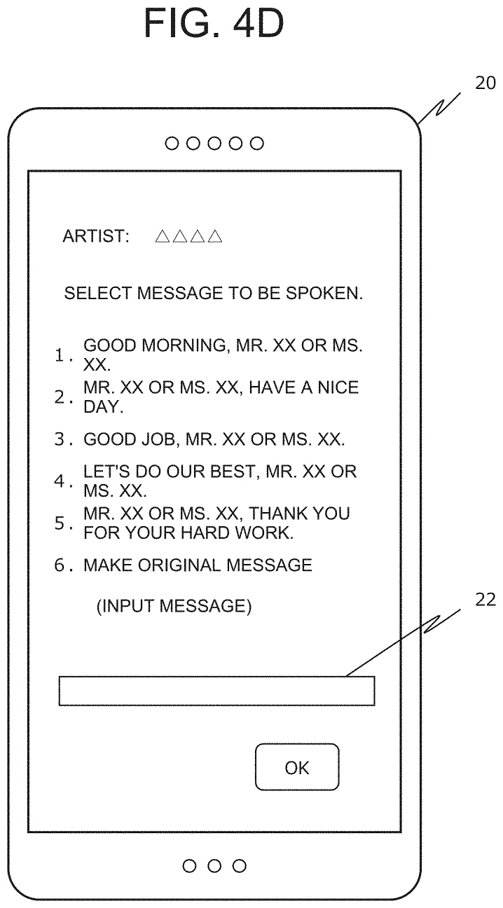

FIG. 4A is an illustrative view showing an example of an operation performed by the user for access to a service for the generation of the voice message-containing image in this embodiment. As shown in FIG. 4A, the service described above can be accessed, only by members who have previously performed an unillustrated registration procedure, through authentication processing in which an ID and a password provided at the time of the registration are input.

When the processor of the front end server 30 serving as the selection receiver 11 recognizes that the portable communication terminal 20 logs in to the service (step S11), the processor of the front end server 30 provides, to the portable communication terminal 20, information for the selection of an image (step S13). This is intended for the selection of any one of images that can be provided as the voice message-containing image by the user. Then, the selection of the image by the user is received with the portable communication terminal 20 (step S15).

FIGS. 4B and 4C are illustrative views showing an example of an operation of selecting the image used for the voice message-containing image performed by the user in this embodiment. In this embodiment, the image is assumed to be a portrait photograph of an artist selected by the user.

As shown in FIG. 4B, the processor of the front end server 30 serving as the selection receiver 11 displays, on the screen of the portable communication terminal 20, a screen for receiving an operation of selecting the artist. In an example shown in FIG. 4B, a keyword related to the artist is input into a search phrase input field 21, and thus it is possible to perform a search. It is also possible to make a selection from the display of a list of artist names. Furthermore, it is possible to make a selection from the display of a list of titles. Genres are narrowed from the display of a list of the genres, and then it is possible to sequentially perform narrowing by use of the artist name and the title.

When the user uses the displayed screen to perform the operation of selecting the artist, then the processor of the front end server 30 serving as the selection receiver 11 displays, on the screen of the portable communication terminal 20, as shown in FIG. 4C, candidates of the portrait photograph of the selected artist. The user touches and selects any one of the portrait photographs, and operates an “OK” key to select the image.

Then, the processor of the front end server 30 serving as the selection receiver 11 receives the selection or input of spoken content by the user who uses the portable communication terminal 20 (step S17). Here, the spoken content to be associated with the selected image is selected.

FIG. 4D is an illustrative view showing an example of an image for receiving the selection or input of the spoken content in this embodiment. As shown in FIG. 4D, the user can select any one of a plurality of established spoken patterns. A portion of “Mr. xx or Ms. xx” included in the established spoken patterns is replaced by the name of the user which is registered. As described above, even when the established spoken patterns are used, the portion thereof is personalized. Instead of the selection of the established spoken pattern, the user can input an arbitrary spoken pattern into a spoken content input field 22.

According to whether the spoken content is obtained as a result of the selection of any one of the established spoken patterns by the user or is input by the user, the processor of the front end server 30 serving as the selection receiver 11 performs processing corresponding to the selection (step S19). In particular, when the spoken pattern is input (no in step S19), the front end server 30 checks whether or not the spoken pattern which is input satisfies predetermined conditions. The conditions may include, for example, constraints related to the length, the language and the field of the speaking. Whether or not a phrase (forbidden words) which is not appropriate as the spoken content of the selected artist is included may be checked (step S21). The front end server 30 previously stores conditions such as constraints and forbidden words applied to all images and constraints and forbidden words specific to each artist. When the spoken pattern which is input does not satisfy one of the conditions, the processor of the front end server 30 serving as the selection receiver 11 notifies the information thereof to the user so as to request the user to correct the spoken pattern (no in step S21).

On the other hand, when the spoken content is obtained as a result of the selection of any one of the established spoken patterns (yes in step S19) or when the spoken pattern which is input satisfies the conditions (yes in step S21), the following processing is performed. The processor of the front end server 30 serving as the voice data generation processing processor 12 transmits, to the voice synthesis server 40, profile information which is previously associated with the selected image and the spoken pattern which is selected or input so as to cause the voice synthesis server 40 to perform voice synthesis (step S23).

Here, the profile information includes parameters for determining the tone, the intonation and the like of the speaking corresponding to the image. Specific examples of the parameter include the emotional parameters of “joy”, “anger” and “sadness”, the parameter of “pitch” related to the pitch of the voice, the parameter of “speaking speed” related to the speed of the speaking and the parameter of “intonation” related to the magnitude of the intonation. For each of the six parameters, within a range of values from −100% serving as the minimum value to +100% serving as the maximum value, the tone, the intonation and the like of the speaking corresponding to the image are determined. Preferably, parameter values are previously associated with the selectable images.

The profile information includes the names of users which are used for the calling of “Mr. xx or Ms. xx” described above.

The profile information further includes information for adding values to the voice messages. An example thereof is information related to the birth date of the user. When the voice data is reproduced on the birthday or around the birthday, a spoken pattern such as “Happy birthday.” or “Your birthday is coming soon. Happy birthday.” may be added to basic spoken patterns. A spoken pattern such as “Happy birthday for the age of xx.” may be added. Furthermore, when the voice data is reproduced on the day or around the day when the artist debuted, a spoken pattern such as “It has been ΔΔ years since I debuted.

Furthermore, the profile information may include the address of home or a workplace. For example, when position information at the time of reproduction of the voice message matches the address of home, a spoken pattern such as “Welcome home.” may be added. When the position information matches the address of a workplace, a spoken pattern such as “Thank you for your hard work.” may be added. Furthermore, when the voice message is reproduced at an event venue held by the artist, a spoken pattern such as “Thank you for coming.” suitable for the site may be added.

When the profile information is changed, for example, when the address of home or the workplace is changed, the processor of the front end server 30 serving as the voice data generation processing processor 12 may cause the voice synthesis server 40 to generate the voice data of spoken content corresponding to the change.

When the voice data generated in the voice synthesis server 40 is directly stored in the voice storage server 50, the front end server 30 serving as the voice data storage processing processor 13 also provides an instruction indicating the information thereof to the voice synthesis server 40. When the generated voice data is temporarily acquired from the voice synthesis server 40, after the acquisition of the voice data, the front end server 30 serving as the voice data storage processing processor 13 transmits the voice data to the voice storage server 50 and stores the voice data therein.

The voice synthesis server 40 which receives an instruction from the front end server 30 serving as the voice data generation processing processor 12 responds to the instruction to perform the following processing. The tone, the intonation and the like of the voice used for the voice synthesis are determined from the profile information (see step S25 shown in FIG. 3B as reference or corresponding processing), and then the voice synthesis is performed according to the artist whose spoken pattern is selected and the tone, the intonation and the like which are determined (see step S27 shown in FIG. 3B as reference or corresponding processing). On at least one of the tone and the intonation of the voice used for the voice synthesis, for not only one but some types thereof, the voice synthesis may be performed. Then, based on a period and a time when the generated voice data is reproduced and the profile information, any one of a plurality of types of voice data of the tone and the intonation may be selected. When the voice data is reproduced, which one of a plurality of types of tones and intonations is applied may also be determined, and thus the voice data to which the tone and the intonation that are determined are applied may be provided.

In a preferred form, the voice synthesis server 40 generates, in addition to the basic spoken patterns transmitted from the voice data generation processing processor 12, various synthetic voices of spoken content for adding values are generated based on the profile information. Regardless of the profile information, synthetic voices of spoken content for adding values may be generated. For example, according to the time zone when the reproduction is performed, a synthetic voice for speaking such as “Good morning.”, “Hello.” or “Good evening” may be generated.

When an instruction is received from the front end server 30 serving as the voice data storage processing processor 13, the generated voice data is transmitted to the voice storage server 50 and is stored therein. In a different form, the voice synthesis server 40 transmits the generated voice data to the front end server 30 serving as the voice data storage processing processor 13.

The front end server 30 which receives the voice data serves as the voice data storage processing processor 13 and transmits the voice data to the voice storage server 50 and stores it therein. For a spoken pattern for adding values, information for determining whether or not the spoken pattern is added is stored so as to be associated with the voice data. For example, information related to the birth date, information related to the address of home or the workplace and the like are stored so as to be associated therewith.

The voice storage server 50 which receives the voice data stores the received voice data based on the instruction from the voice data storage processing processor 13. Then, the access information used for access to the stored voice data is transmitted to the front end server 30. The front end server 30 serving as the voice data storage processing processor 13 receives the access information (step S29).

As a specific form of the access information, a URL for identifying the voice data stored in the voice storage server 50 is mentioned. However, there is no limitation to this form as long as the access information is information in which the voice storage server 50 that receives the access information can uniquely identify the stored voice data.

When the access information is received from the voice storage server 50, the processor of the front end server 30 serving as the access information superimposer 14 converts the access information received from the voice storage server 50 into an image (step S31). In this embodiment, the access information superimposer 14 is assumed to convert the access information into a two-dimensional code. Then, the image selected by the user is acquired, and the two-dimensional code is superimposed on the image (step S33).

Although here, images that can be provided as the materials of the voice message-containing image are previously stored in the front end server 30, instead of or in addition to such a configuration, images may be stored in an external server (not shown), and the images stored in the server may be selected and acquired.

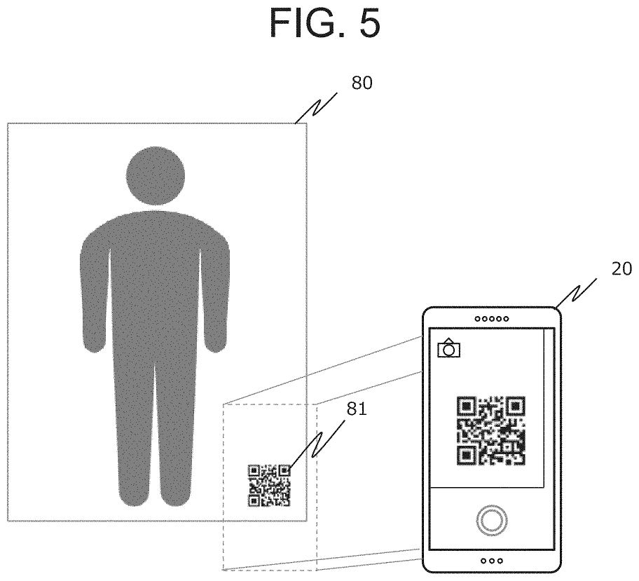

FIG. 5 is an illustrative view showing an example of the voice message-containing image and an example of an operation of reproducing the voice message in this embodiment. As shown in FIG. 5, in the voice message-containing image 80, a two-dimensional code 81 is superimposed on a region of part of the portrait photograph of the selected artist. The two-dimensional code 81 is the access information to the voice data which is associated with this image.

When the user who is a member registered in the service for the voice message-containing image uses the portable communication terminal 20 storing the ID and the password for the authentication processing to shoot the two-dimensional code 81, the user can access the voice data, and thus the voice data is reproduced with the portable communication terminal 20. Here, the portable communication terminal 20 used for the reproduction of the voice data may be the same as the portable communication terminal 20 used for the generation of the voice message-containing image or may be different therefrom.

In the form described above, the portable communication terminal 20 used for the reproduction of the voice data needs to store the ID and the password for the authentication processing to the service for the voice message-containing image. Even when the ID and the password are not previously stored, as long as the ID and the password are input at the time of reproduction of the voice data, it may be allowed to perform the reproduction. The person who can reproduce the voice message is the user who is the member registered in the service for the voice message-containing image.

In a different form, the authentication processing is not necessary for the reproduction of the voice data, and anyone can access the voice data to perform the reproduction. In this way, the voice message-containing image can be used as, for example, an advertising medium. A configuration may be adopted in which when the voice data is generated, the user can specify whether or not authentication for the reproduction is needed.

A description will be given with reference back to the flowchart.

In the description of step S33 shown in FIG. 3B, the processor of the front end server 30 serving as the access information superimposer 14 superimposes the two-dimensional code on the selected image to generate the voice message-containing image 80.

Then, the processor of the front end server 30 serving as the image storage processing processor 15 transmits the voice message-containing image 80 to the network print server 60 to store it therein (step S35 of FIG. 3C). Furthermore, the processor of the front end server 30 serving as the identification information generation processing processor 16 instructs the network print server 60 to generate and provide the identification information used for the output of the voice message-containing image 80 stored in the network print server 60.

The network print server 60 responds to the instruction described above to store the voice message-containing image 80 (see step S37 shown in FIG. 3C as reference or corresponding processing). Then when the stored image is output, the identification information used for specifying the image is generated (see step S39 shown in FIG. 3C as reference or corresponding processing). Then, the generated identification information is transmitted to the front end server 30 serving as the identification information generation processing processor 16. When receiving the identification information, the processor of the front end server 30 serving as the identification information provision processing processor 17 transmits the identification information to the portable communication terminal 20 to present the identification information to the user.

When the processing in step S35 described above is performed, the processor of the front end server 30 serving as the identification information provision processing processor 17 may also transmit the identification information generated by the network print server 60 to the portable communication terminal 20 and provide an instruction to present the identification information to the user. The flowchart of FIG. 3C shows this form.

The portable communication terminal 20 which receives the identification information displays the identification information on the screen to present it to the user (see step S41 shown in FIG. 3C as reference or corresponding processing).

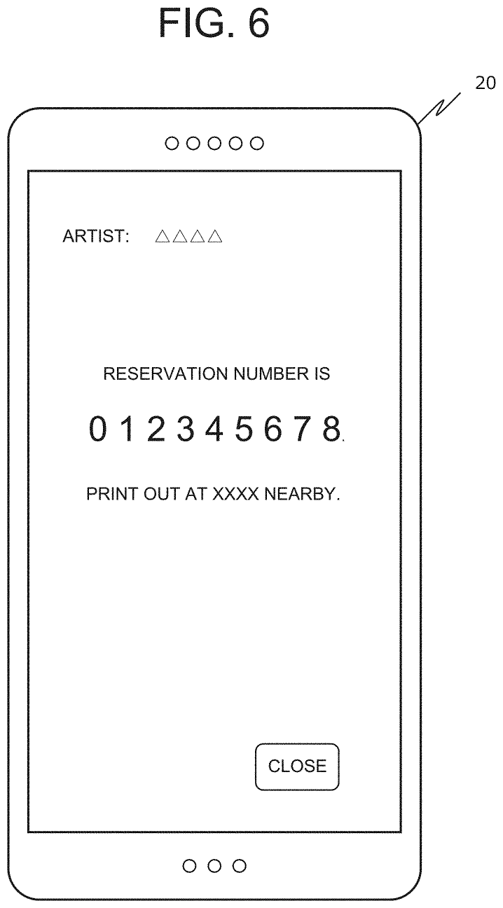

FIG. 6 is an illustrative view showing an example of the presentation of the identification information for the voice message-containing image to the user in this embodiment. In the example shown in FIG. 6, a reservation number serving as the identification information is presented to the user. The user goes to a location where the image processing device 70 is installed, and can output the voice message-containing image 80 with the presented reservation number. In this embodiment, the image processing device 70 is a multifunctional machine installed in a convenience store.

The procedure described above is the procedure for the processing for the generation of the voice message-containing image.

Then, a procedure for processing for the output of the voice message-containing image will be described.

As shown in FIG. 6, the user who receives the presentation of the reservation number used for the output of the voice message-containing image goes to the convenience store where the image processing device 70 is installed so as to perform an operation of outputting the voice message-containing image.

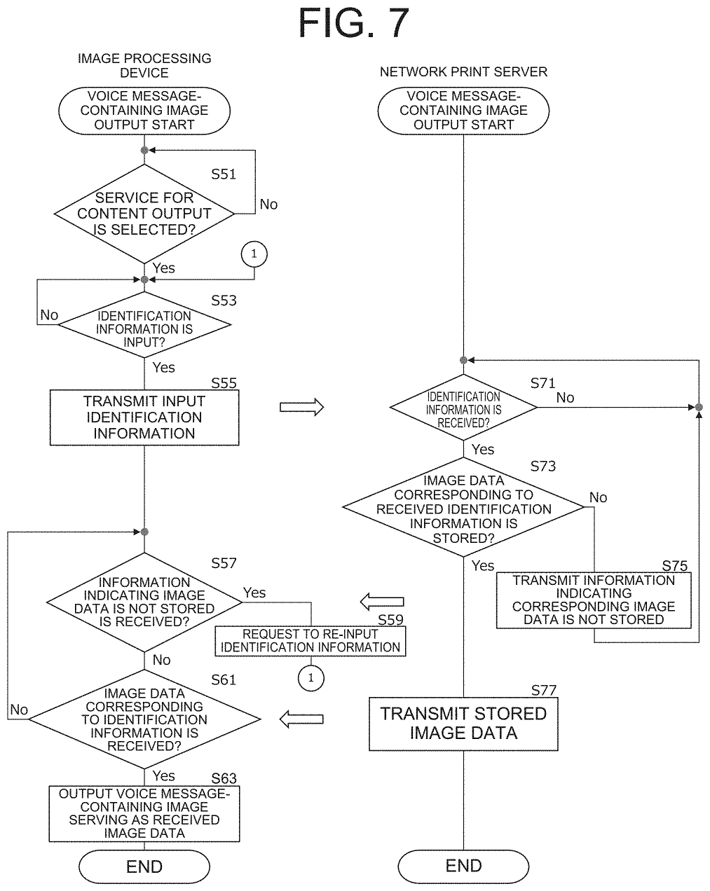

FIG. 7 is a flowchart showing the flow of the processing for the output of the voice message-containing image in this embodiment.

As shown in FIG. 7, the user performs an operation of performing an output service for service content on the image processing device 70. When the processor of the image processing device 70 receives an operation of requesting the output for the service content performed by the user (yes in step S51), the processor of the image processing device 70 waits for an input of the identification information (reservation number) (step S53). When the identification information is input (yes in step S53), the processor of the image processing device 70 transmits the input identification information to the network print server 60 (step S55). Then, the processor of the image processing device 70 waits for a response from the network print server 60 (the loop of steps S57 and S61).

On the other hand, the processor of the network print server 60 waits for the transmission of the identification information for output from the image processing device 70 (step S71), and checks whether or not image data corresponding to the received identification information is stored (step S73). When the image data corresponding to the identification information is not stored (no in step S73), the information thereof is transmitted to the image processing device 70 (step S75). Then, the processing is returned to step S71, and the reception of the next identification information is waited for.

When the image data corresponding to the received identification information is stored (yes in step S73), the stored image data is transmitted to the image processing device 70 (step S77).

When the processor of the image processing device 70 receives, from the network print server 60, a notification indicating that the image data is not stored (yes in step S57), the information thereof is displayed on an operator (not shown) to request the user to check and re-input the identification information (step S59). Then, the processing is returned to step S53, and the re-input of the identification information is waited for.

On the other hand, when the image data is received from the network print server 60 (yes in step S61), the received image data, that is, the voice message-containing image (see FIG. 5) is printed so as to be output (step S63).

The processing described above is the processing for the output of the voice message-containing image.

Then a procedure for processing for the reproduction of the voice message-containing image will be described.

When as shown in FIG. 5, the user uses the portable communication terminal 20 to shoot the two-dimensional code 81 superimposed on the voice message-containing image 80, the user can access the image data associated therewith, and thus the voice data is reproduced with the portable communication terminal 20.

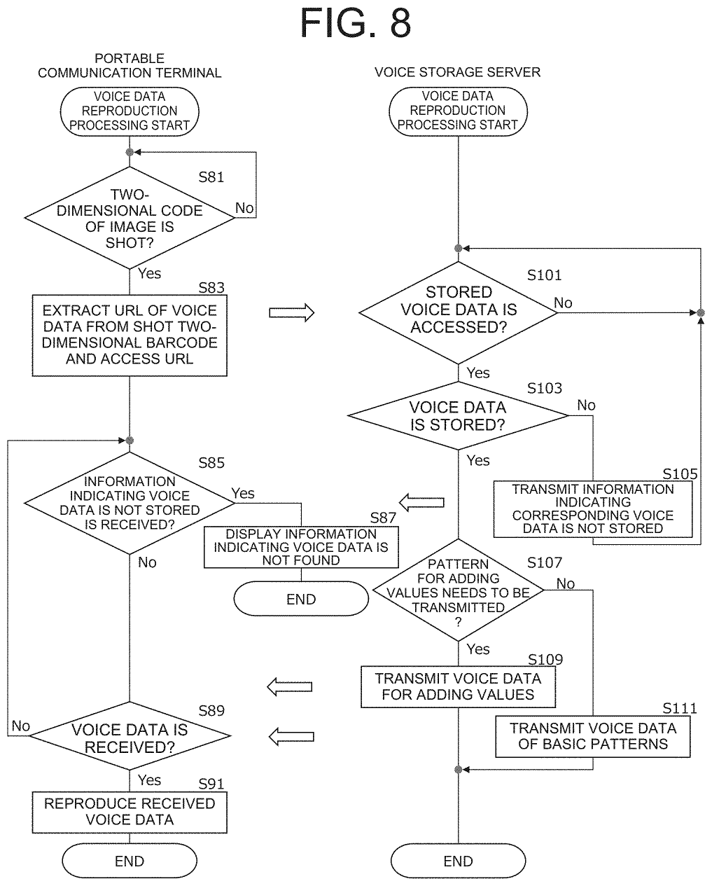

FIG. 8 is a flowchart showing the flow of the processing for the reproduction of the voice message-containing image in this embodiment.

As shown in FIG. 8, when the two-dimensional code superimposed on the voice message-containing image is shot with an internal camera (not shown) (yes in step S81), the processor of the portable communication terminal 20 performs the following processing. The access information to the voice data is extracted from the two-dimensional code which is shot, and thus the voice data stored in the voice storage server 50 is accessed (step S83). Then, a response from the voice storage server 50 is waited for (the loop of steps S85 and S89). In this embodiment, the access information is a URL unique for each piece of voice data stored in the voice storage server 50.

In a preferred form, when the voice storage server 50 is accessed, in addition to the access information, information is added which is used for determining whether or not a spoken pattern for adding values is included. For example, such information is information related to the present location. When the voice storage server 50 deals with users located all over the world, information related to the date and time of the location where the user is present may be added. This is because when a condition for determining whether or not the spoken pattern is included depends on the date and time, an accurate determination is made based on the date and time of the location where the user is present.

When the voice storage server 50 receives an access request for the stored voice data from the external device (yes in step S101), the voice storage server 50 checks whether or not the voice data corresponding to the access information added to the access request is stored (step S103). When the voice data corresponding to the access information is not stored, the information thereof is transmitted to the device which transmits the access request (step S105). Then, the processing is returned to step S101, and the next access request is waited for.

On the other hand, when the voice data corresponding to the received access information is stored, the voice storage server 50 determines whether or not a spoken pattern for adding values needs to be included in addition to the basic spoken patterns (step S107). When the spoken pattern satisfies a condition in which values are added (yes in step S107), the voice data including the spoken pattern described above is transmitted to the portable communication terminal 20 which makes the access request (step S109).

On the other hand, when the spoken pattern does not satisfy the condition in which values are added (no in step S107), the voice data for the basic spoken patterns is transmitted to the portable communication terminal 20 which makes the access request (step S111).

When the processor of the portable communication terminal 20 receives, from the voice storage server 50, a notification indicating that the voice data is not stored (yes in step S85), the information thereof is displayed on the screen to notify the information to the user, and the processing is completed (step S87).

On the other hand, when the voice data is received from the voice storage server 50 (yes in step S89), the received voice data is reproduced (step S91).

The processing described above is the processing for the reproduction of the voice message-containing image.

### Embodiment 3

In this embodiment, the processor of the front end server 30 serving as the voice data generation processing processor 12 may acquire the voice data generated with the voice synthesis server 40 in the processing of step S27 shown in FIG. 3B, transmit the generated voice data to the portable communication terminal 20 and reproduce it therewith. In this way, before the generated voice data is stored in the voice storage server 50, it is possible to cause the user to tentatively listen to the generated voice data so as to check it. When the user who tentatively listens to the generated voice data does not like the voice data, the processing is returned to step S17 described above, and thus it is possible to re-select the spoken content. In this way, the user can check the tone, the intonation and the like of speaking in which the selected or input spoken content is adjusted, and the checked voice data can be stored in the voice storage server 50.

Furthermore, a configuration may be adopted in which the values of the parameters for determining the tone, the intonation and the like of speaking can be selected or adjusted. In the description of embodiments 1 and 2, the values of the parameters for determining the tone, the intonation and the like of speaking are previously associated with each of the selectable images. By contrast, in this form, the user can further change the values of the parameters associated with the image to adjust them into a preferred state. The values of the parameters for the image can also be selected. The choices of the values of the parameters may be previously associated with the image. The choices may also be prepared regardless of the image or both the methods may also be combined together. The user can adjust or select the values of the parameters for the tone, the intonation and the like of speaking, listen to the voice data tentatively and repeatedly until the voice data is changed into a desired state and store the voice data in the voice storage server 50.

(i) As described above, a generation control device for a voice message-containing image according to this invention includes: a selection receiver that receives the selection of any one of images that can be provided and the selection or input of spoken content to be associated with the selected image; a voice data generation processing processor that generates voice data of the spoken content which is selected or input; a voice data storage processing processor that stores the generated voice data to be accessible; an access information superimposer that superimposes access information to the stored voice data on the selected image; and an image storage processing processor that stores a voice message-containing image on which the access information is superimposed such that the voice message-containing image can be output.

In this invention, the images that can be provided are one or more images that are previously determined as images with which the voice data is associated and which can be provided. Examples of the specific form thereof include the images for bromides of celebrities in the embodiment described previously and the like.

The spoken content is the content of the voice data which is associated with the images described above.

In the selection of the spoken content, a user selects a desired one of a plurality of predetermined patterns, and in the input of the spoken content, the user arbitrarily inputs the content of speaking. However, in the spoken content which can be input, for example, given restrictions may be imposed on the length, the language and the field of speaking.

The voice data generation processing processor applies a known voice synthesis technique to generate the voice data.

The access information superimposer superimposes the access information serving as an image on the selected image. In an example of the specific form thereof, the access information of a one-dimensional code or a two-dimensional code is superimposed on the selected image. The one-dimensional code or the two-dimensional code which is superimposed is read, and thus it is possible to access voice data associated with the image and to reproduce the voice data. The voice storage server in the embodiment described previously stores the generated voice data.

The voice message-containing image on which the access information is superimposed is stored in a predetermined place by the image storage processing processor. The network print server in the embodiment described previously stores the generated voice message-containing image.

The selection receiver, the voice data generation processing processor, the voice data storage processing processor, the access information superimposer and the image storage processing processor may be formed as follows. Specifically, a processor such a CPU (Central Processing Unit) or a MPU (Micro Processing Unit) may execute control programs previously stored in a memory so as to realize the functions thereof. In the form described above, hardware resources including the processor, the memory and peripheral circuits such as an input/output interface circuit and a communication interface circuit and software resources of the control programs are organically combined to realize the functions.

Furthermore, preferred forms of this invention will be described.

(ii) The generation control device may further include: an identification information generation processing processor that generates identification information used for the output of the voice message-containing image; and an identification information provision processing processor that provides the generated identification information to the user.

In this way, the user uses the provided identification information to be able to access the voice message-containing image and output the voice message-containing image.

(iii) When the selection receiver receives the input of the spoken content, the selection receiver may determine whether or not predetermined forbidden words to the image with which the spoken content is associated are included in the input, and when the forbidden words are included, the voice data based on the input may be prevented from being generated by the voice data generation processing processor.

In this way, the forbidden words corresponding to all images or the selected image are previously determined, and thus it is possible to reduce the generation of voice data having content which is not suitable for the image. For example, when forbidden words corresponding to a celebrity are previously determined, messages of unsuitable content are prevented from being generated with the voice of the celebrity, with the result that it is possible to protect the personality of the celebrity.

(iv) The generation control device may further include a communicator that performs exchange with an external device, and the generation control device may perform at least any one of receiving, by the selection receiver, the selection of the image and the selection or input of the spoken content through communication with the external device, causing, by the voice data generation processing processor, the external device to generate the voice data, causing, by the voice data storage processing processor, the external device to store the generated voice data, causing, by the access information superimposer, the external device to perform processing for superimposing the access information on the selected image and causing, by the image storage processing processor, the external device to store the voice message-containing image.

In this way, it is possible to cooperate with the external device capable of performing exchange through communication to generate the voice message-containing image.

The generation control device may further perform at least one of causing, by the identification information generation processing processor, the eternal device to generate the identification information and transmitting, by the identification information provision processing processor, the identification information to the external device and providing the identification information to the user therewith.

In this way, it is possible to provide the identification information used for the output of the voice message-containing image to the user with the external device capable of performing exchange through communication.

(v) The preferred forms of this invention include a processing terminal used for generation of a voice message-containing image, and the processing terminal includes: a terminal operator that receives an operation of selecting an image and an operation of selecting or inputting spoken content to be associated with the image; a terminal communicator that transmits the received selection of the image and the received selection or input of the spoken content to the generation control device for a voice message-containing image described above so as to receive the identification information; and a terminal display that provides the received identification information to the user. The portable communication terminal in the embodiment described previously corresponds to the processing terminal in this form.

(vi) The preferred forms of this invention include a processing terminal used for reproduction of voice data for a voice message-containing image, and the processing terminal includes: an access information acquirer that acquires the access information from the voice message-containing image output with the identification information generated by the generation control device for a voice message-containing image described above; an access processing processor that uses the acquired access information to access the stored voice data; and a voice reproducer that reproduces the accessed voice data. The portable communication terminal in the embodiment described previously corresponds to the processing terminal in this form.

(vii) The processing terminal may further include an information provider that provides information related to at least any one of a position, a period and a time, and at least any one of the content of the voice data which is reproduced, a tone when the voice data is reproduced and an intonation when the voice data is reproduced may be determined according to at least any one of a position, a period and a time when the voice data is accessed.

(viii) The preferred forms of this invention include a method for generating a voice message-containing image, and the method includes: receiving, by a processor, the selection of any one of images that can be provided and the selection or input of spoken content to be associated with the selected image; generating, by the processor, voice data of the spoken content which is selected or input; storing, by the processor, the generated voice data to be accessible; superimposing, by the processor, access information to the stored voice data on the selected image; and storing, by the processor, a voice message-containing image on which the access information is superimposed such that the voice message-containing image can be output.

The preferred forms of this invention include a combination of some of the forms described above.

In addition to the embodiments described above, various variations in this invention are possible. The variations should be considered to be included in the scope of this invention. This invention should include meanings equivalent to the scope of claims and all variations within the scope.

What is claimed is:

1. A generation control device for a voice message-containing image, the generation control device comprising:
a selection receiver that receives selection of any one of images that can be provided and selection or input of spoken content to be associated with the selected image;
a voice data generation processing processor that generates voice data of the spoken content which is selected or input;
a voice data storage processing processor that stores the generated voice data to be accessible;
an access information superimposer that superimposes access information to the stored voice data on the selected image; and
an image storage processing processor that stores a voice message-containing image on which the access information is superimposed such that the voice message-containing image can be output.

2. The generation control device according to claim 1, further comprising:
an identification information generation processing processor that generates identification information used for the output of the voice message-containing image; and
an identification information provision processing processor that provides the generated identification information to a user.

3. The generation control device according to claim 1,
wherein when the selection receiver receives the input of the spoken content, the selection receiver determines whether or not predetermined forbidden words to the image with which the spoken content is associated are included in the input, and when the forbidden words are included, the voice data based on the input is prevented from being generated by the voice data generation processing processor.

4. The generation control device according to claim 1, further comprising:
a communicator that performs exchange with an external device,
wherein the generation control device performs at least any one of
receiving, by the selection receiver, the selection of the image and the selection or input of the spoken content through communication with the external device,
causing, by the voice data generation processing processor, the external device to generate the voice data,
causing, by the voice data storage processing processor, the external device to store the generated voice data,
causing, by the access information superimposer, the external device to perform processing for superimposing the access information on the selected image and
causing, by the image storage processing processor, the external device to store the voice message-containing image.

5. A processing terminal used for generation of a voice message-containing image, the processing terminal comprising:
a terminal operator that receives an operation of selecting an image and an operation of selecting or inputting spoken content to be associated with the image;
a terminal communicator that transmits the received selection of the image and the received selection or input of the spoken content to the generation control device for a voice message-containing image according to claim 2 so as to receive the identification information; and
a terminal display that provides the received identification information to a user who performs the operation.

6. A processing terminal used for reproduction of voice data for a voice message-containing image, the processing terminal comprising:
an access information acquirer that acquires the access information from the voice message-containing image output with the identification information generated by the generation control device for a voice message-containing image according to claim 2;
an access processing processor that uses the acquired access information to access the stored voice data; and
a voice reproducer that reproduces the accessed voice data.

7. The processing terminal according to claim 6, further comprising:
an information provider that provides information related to at least any one of a position, a period and a time,
wherein at least any one of content of the voice data which is reproduced, a tone when the voice data is reproduced and an intonation when the voice data is reproduced is determined according to at least any one of a position, a period and a time when the voice data is accessed.

8. A method for generating a voice message-containing image, the method comprising:
receiving, by a processor, selection of any one of images that can be provided and selection or input of spoken content to be associated with the selected image;
generating, by the processor, voice data of the spoken content which is selected or input;
storing, by the processor, the generated voice data to be accessible;
superimposing, by the processor, access information to the stored voice data on the selected image; and
storing, by the processor, a voice message-containing image on which the access information is superimposed such that the voice message-containing image can be output.
